(19) United States
(12) Patent Application Publication
(10) Pub. No.: US 2004/0045906 A1
(43) Pub. Date: Mar. 11, 2004

(54) Compositions and methods for the removal of colorants from solution

(76) Inventor: Phil Wiseman, Independence, KY (US)

Correspondence Address: NATH & ASSOCIATES, 1030 15th STREET, 6TH FLOOR, WASHINGTON, DC, 20005, US

(21) Appl. No.: 10/237,970

(22) Filed: Sep. 10, 2002

(51) Int. Cl. C02F 1/52

(52) U.S. Cl. 210/708

(57) ABSTRACT

The present invention relates to the treatment of a solution that contains colorants and, in particular, compositions and methods for the removal of colorants from a solution.

### BACKGROUND OF THE INVENTION

1. Field of Invention

The present invention relates to the treatment of a solution that contain colorants and, in particular, compositions and methods for the removal of colorants from a solution.

2. Description of Related Art

Industrial activities that use colorants produce waste systems that include colorants, inks, dyes and coatings in solution. These industrial activities include, but are not limited to the following: printing applications; inorganic and organic coating manufacturing; inorganic and organic ink manufacturing; inorganic and organic pigment manufacturing and fabric dyeing applications.

By way of illustration, the commercial printing industry is one of the largest and most geographically diverse manufacturing industries in the U.S. with 50,000 printing companies employing over one million people. Printers mass produce printed communication by utilizing a variety of printing presses and processes that apply ink to materials such as paper, books, magazines, newspapers, brochures, labels, plastics, metals, textiles and ceramics.

Use and generation of potentially hazardous materials is part of daily printing operations. Each year over two billion pounds of ink, mostly petroleum-based, are used by this industry. Distinct environmental concerns are associated with specific printing applications, equipment and chemicals utilized by printing operations. All processes share a common trait; they generate some level of hazardous waste. Improper management of inks that contain chemicals can result in contamination of soil and water. In addition to ink components, the majority of toxic chemicals are used in press cleaning and blanket washes. Readily available and affordable, these chemicals remove ink and evaporate quickly for minimal press downtime and greater efficiency and profitability. However, they present serious environmental risks. Petroleum-based cleaners contain more than 60% volatile organic compounds (VOCs), which contribute to the creation of smog. Also, these substances are comprised of a complex blend of hydrocarbons derived from crude oil that contain hazardous attributes, which make them flammable, toxic, corrosive and/or explosive.

For commercial printers, waste management is a cost of doing business just like water, gas and electricity. As air regulations controlling volatile organic compounds (VOCs) become more strict, many flexographic printers are switching to water-based ink technology to reduce their emissions. With water-based ink production on the rise, the flexographic industry has begun exploring alternatives for handling the waste generated from working with these inks.

The assumption that these inks and their wash-up wastes can simply go down the drain is misleading. Different federal, state and local regulations apply to the wastewater generated by industrial facilities. Depending on where or from what system a facility discharges wastewater determines which regulations and limitations apply.

Wastewater associated with the use of water-based inks is contaminated with colorants (pigments and dyes), vehicles (alkali-soluble, emulsions or colloidal-dispersion chemistries), auxiliary solvents (alcohols, glycols and glycol ethers) and additives (waxes, plasticizers and defoamers). Colored wastewater may also be an aesthetic concern. It is often an issue of the quantity and/or quality of certain chemistries and pigments that can exceed maximum discharge allowances for particular regions and circumstances.

A popular treatment for removing colorants from waste solution consists of adding large amounts of aluminum chloride, lime and cationic emulsion polymer. However, the effects of using these compositions and methods are often undesirable and incomplete. The treatment process takes many hours, the pH varies widely during treatment, the colorant “filter cake” that remains after treatment settles poorly and is often wet and hard to manage, and the remaining solution is hazy.

Accordingly, there exists a need for a simple, cost-effective composition and method for dealing with colorants, coatings, inks, dyes and pigments in waste solution. The present invention will enable the various industries that are in need of this technology to properly dispose of or recycle the colorant in an effort to conserve financial resources while simultaneously being in compliance with existing environmental regulations.

### SUMMARY OF THE INVENTION

The present invention relates to the treatment of a solution that contain colorants and, in particular, compositions and methods for the removal of colorants, pigments, inks, dyes and coatings from a solution

A preferred embodiment of the invention is a composition for the removal of colorant from a solution comprising an aluminum chloride solution and a cationic polyamine.

Another preferred embodiment of the invention is a composition for the removal of colorant from a solution comprising aluminum chloride, hydrogen chloride and water.

Another preferred embodiment of the invention is a composition for the removal of colorant from a solution comprising an aluminum chloride solution and a cationic polyamine, wherein said aluminum chloride solution is 26%-28% aluminum chloride, 0%-1% hydrogen chloride, and 71%-74% water by volume.

Another preferred embodiment of the invention is a composition for the removal of colorant from a solution comprising an aluminum chloride solution and a cationic polyamine, wherein said cationic polyamine contains between approximately 40% and approximately 60% degree of charge.

Another preferred embodiment of the invention is a composition for the removal of colorant from a solution comprising an aluminum chloride solution and a cationic polyamine, wherein said cationic polyamine is selected from the group consisting of Callaway 4000, Polymer Research 507, Chemtall 4420, Mid South 9507, Ashland Chemical Amerfloc series and Neo Solutions 3500.

Another preferred embodiment of the invention is a composition for the removal of colorant from a solution comprising an aluminum chloride solution and a cationic polyamine, wherein said aluminum chloride solution is between 40% and 60% of the total volume and said cationic polyamine is between 40% and 60% of the total volume.

Another preferred embodiment of the invention is a composition for the removal of colorant from a solution comprising an aluminum chloride solution and a cationic polyamine, wherein said aluminum chloride solution is 50% of the total volume and said cationic polyamine is 50% of the total volume.

Another preferred embodiment of the invention is a method of removing colorant from a solution comprising adding an effective amount of the composition for the removal of colorant from a solution comprising an aluminum chloride solution and a cationic polyamine to the waste solution to break the colorant from the solution, adding an effective amount of a cationic polymer to enhance the settling of the colorant from the solution and filtering the solution.

Another preferred embodiment of the invention is a method of removing colorant from a solution comprising adding an effective amount of the composition for the removal of colorant from a solution comprising an aluminum chloride solution and a cationic polyamine to the waste solution to break the colorant from the solution, adding an effective amount of a cationic polymer to enhance the settling of the colorant from the solution and filtering the solution, wherein the amount of the composition is between 500 ppm and 4000 ppm of the total volume of the solution.

Another preferred embodiment of the invention is a method of removing colorant from a solution comprising adding an effective amount of the composition for the removal of colorant from a solution comprising an aluminum chloride solution and a cationic polyamine to the waste solution to break the colorant from the solution, adding an effective amount of a cationic polymer to enhance the settling of the colorant from the solution and filtering the solution, wherein the amount of the cationic polymer that is added is between 0.01% and 1.0%, preferably between 0.2% and 0.4%, of the total volume of the solution.

Another preferred embodiment of the invention is a method of removing colorant from a solution comprising adding an effective amount of the composition for the removal of colorant from a solution comprising an aluminum chloride solution and a cationic polyamine to the waste solution to break the colorant from the solution, adding an effective amount of a cationic polymer to enhance the settling of the colorant from the solution and filtering the solution, wherein the cationic polymer has a molecular weight between approximately 6 million and approximately 12 million and has a degree of charge between approximately 10% and approximately 80%.

Another preferred embodiment of the invention is a method of removing colorant from a solution comprising adding an effective amount of the composition for the removal of colorant from a solution comprising an aluminum chloride solution and a cationic polyamine to the waste solution to break the colorant from the solution, adding an effective amount of a cationic polymer to enhance the settling of the colorant from the solution and filtering the solution, wherein the cationic polymer is selected from the group consisting of Cytec 1507, Chemtall EM804B and Neo Solutions 4422.

Another preferred embodiment of the invention is a method of removing colorant from a solution comprising adding an effective amount of the composition for the removal of colorant from a solution comprising an aluminum chloride solution and a cationic polyamine to the waste solution to break the colorant from the solution, and filtering the solution by membrane filtration.

Another preferred embodiment of the invention is a method of removing colorant from a solution comprising adding an effective amount of the composition for the removal of colorant from a solution comprising an aluminum chloride solution and a cationic polyamine to the waste solution to break the colorant from the solution, and filtering the solution by membrane filtration, wherein the amount of aluminum chloride solution and cationic polyamine composition that is added is between 500 ppm and 4000 ppm of the total volume of the solution.

### BRIEF DESCRIPTION OF THE DRAWINGS

FIG. 1 is a photograph of waste samples numbers I-VII taken at a paper coatings manufacturing facility. FIG. 1 shows the qualitative results achieved by using a 2000 ppm concentration of various ratios of aluminum chloride solution to polyamine solution. The precise ratios of aluminum chloride/polyamine solution are listed in Table 3.

FIG. 2 is a photograph of waste samples I-IV taken at a paper coatings manufacturing facility. FIG. 2 shows the qualitative results achieved by using various concentrations of a cationic polymer at 80% degree of charge, 8 million molecular weight to gather the colorant from the waste sample after treatment with a 3000 ppm concentration of a 1:1 ratio of aluminum chloride solution and cationic polyamine. The precise concentrations of cationic polymer are listed in Table 4.

FIG. 3 is a photograph of waste samples I-IV taken at a paper coatings manufacturing facility. FIG. 3 shows the qualitative results achieved by using various concentrations of a 1:1 ratio of aluminum chloride solution and cationic polyamine with 30 ppm concentration of a cationic polymer at 80% degree of charge, 8 million molecular weight to gather the colorant from the waste sample. The precise concentrations of 1:1 aluminum chloride solution and cationic polyamine are listed in Table 5.

FIG. 4 is a photograph of identical waste samples taken at a paper coatings manufacturing facility before treatment I and after treatment II. FIG. 4 shows the qualitative results achieved by using a 3000 ppm concentration of a 1:1 ratio of aluminum chloride solution and cationic polyamine with 30 ppm concentration of a cationic polymer at 80% degree of charge, 8 million molecular weight to gather the colorant from the waste sample.

### DETAILED DESCRIPTION OF THE INVENTION

1. Glossary

“Aluminum chloride solution” refers to a solution that contains between 5% and 50% aluminum chloride by volume.

“Aluminum chlorohydrate” refers to aluminum hydroxychloride or Al₂(OH)₅Cl.2H₂O.

“Callaway 4000” refers to a liquid product manufactured by Callaway Chemical Company, which is a unit of Vulcan Chemicals, which is a subsidiary of Vulcan Materials Company. The exact ingredients of Callaway 4000 Series polyamine are not disclosed as they are proprietary information. Callaway 4000 contains a polyamine resin that is 5%-60% by weight. The CAS# for Callaway 4000 is 42751-79-1. Callaway 4000 Series polyamine is clear to hazy in appearance as a light to dark amber liquid. It has a pH from about 5 to about 7, is soluble in water, with a boiling point (bp) of 210-215° F. and a freezing point (fp) of 20-32° F.

“Cationic polyamine” refers to a polyamine that has a positive charge. Callaway 4000 is an example of a cationic polyamine.

“Cationic polymer” refers to a polymer that has a positive charge. An example of a cationic polymer is the cationic polymer-emulsion polyacrylamide that is used to enhance the settling characteristics of the solids and colorants that have been treated by the aluminum chloride/polyamine solution.

“Colorant” refers to any color-containing element, compound or composition including, but not limited to: inks, dyes, coatings and orgainic and inorganic pigments.

“Cytec 1507” refers to a liquid cationic polyacrylamide product with 80% degree of charge, 8 million molecular weight, manufactured by Cytec Industries Inc. It contains 500 ppm of 26%-29% petroleum distillate, CAS No. 064742-47-8 and 10-15 ppm of 1%-2% Acetic acid, CAS No. 000064-19-7.

“Filtration” refers to any semi-permeable filtration device, apparatus, technique or method, including but not limited to: frame and filter press, belt-filter press, membrane filtration, rotary vacuum filtration, evaporation filtration, paper filtration and screen filtration.

“Platinum cobalt unit” refers to a unit of measuring the intensity of color. The higher the value, the more color present in the sample. The lower the value, the less color present in the sample.

“PSI” refers to pounds per square inch, a measurement unit of pressure.

2. Detailed Description

It is an object of the present invention to provide a composition and a method for the removal of colorants and coatings from a solution. In particular, the composition and method are useful for removing colorants and coatings from waste solutions.

To achieve this aim, an aluminum chloride solution and a cationic polyamine are combined and added to the solution to “break” the colorant or coating from the solution. Various ratios and concentrations of aluminum chloride/cationic polyamine have been contemplated and tested. The aluminum chloride solution may contain between 5% and 50% aluminum chloride. The cationic polyamine may contain 30%-70% degree of charge. It has been noted through repeated testing that an aluminum chloride solution of 26%-28% aluminum chloride, 0-1% hydrogen chloride and 71%-74% water by volume yields consistent satisfactory results. It has also been noted that a cationic polyamine with a 50% degree of charge yields consistent satisfactory results. Examples of cationic polyamine that may be used include, but are not limited to Callaway 4000, Polymer Research 507, Chemtall 4420, Mid South 9507, Ashland Chemical Amerfloc series, Neo Solutions 3500 and other equivalent polyamines that may be prepared or purchased commercially. It has been noted through repeated testing that ratios of 40/60, 50/50 and 60/40 aluminum chloride/cationic polyamine at concentrations of 500 ppm-4000 ppm yield consistent satisfactory results.

A cationic polymer is then added to the solution to enhance the settling of the “broken” colorant or coating from the solution. This enables the colorant or coating to be filtered from the solution more effectively. Various concentrations of cationic polymer have been contemplated and tested. The molecular weight of the polymer may range between 6 and 12 million and have a charge of between 10% and 80%. It has been noted through repeated testing that cationic polyamines with between a 10%-80% charge at concentrations of 10 ppm-40 ppm yield consistent satisfactory results. Examples of cationic polymer that may be used include, but are not limited to Cytec 1507, Chemtall EM840B, Neo Solutions 4422 and other equivalent cationic polymers that may be prepared or purchased commercially.

The treated solution is then either filtered to separate the effluent from the colorant waste or centrifuged to settle the waste at the bottom of the container and then the effluent is then poured off or filtered or centrifuged further. The effluent exhibits vastly improved clarity, as shown by the resultant color value measured in platinum cobalt units. Various means of filtering the solution have been contemplated. Any semi-permeable filtration device, apparatus, technique or method, including but not limited to: plate and frame filter press, belt-filter press, membrane filtration, rotary vacuum filtration, evaporation filtration, paper filtration and screen filtration, would provide satisfactory filtration. It has been noted through repeated testing that a plate and frame filter press yields consistent satisfactory results.

Once filtered, the effluent is far better suited for disposal through normal means, i.e. disposal down the drain where it will be treated by the local water treatment authority. The resulting “filter cake” of colorant may be disposed of or recycled in accordance with applicable local, state and/or federal regulations. Accordingly, the present invention provides a simple, cost-effective solution for treating waste solutions while encouraging compliance with existing environmental regulations.

An alternative to the addition of the cationic polymer and further step of filtration is the use of a membrane filter. Membrane filtration can be used to meet special liquid separation requirements and is well known in the art. Several types of membrane filtration are reverse osmosis, nanofiltration, ultrafiltration and microfiltration.

Reverse osmosis is a high-pressure, energy efficient technique for dewatering process streams, concentrating low molecular weight substances in solution and/or purifying water or wastewater. It has the ability to concentrate all dissolved and suspended solids. The permeate contains a very low concentration of dissolved solids. Reverse osmosis is also widely used in the desalination of seawater.

Nanofiltration is a special process selected with reverse osmosis and ultrafiltration are not the ideal choice for separation. Nanofiltration can perform separation applications that are not otherwise economically feasible, such as demineralization, color removal and desalination. In concentration of organic solutes, suspended solids and polyvalent ions, the permeate contains monovalent ions and low-molecular weight organic solutions like alcohol.

Ultrafiltration is a selective fractionation process utilizing pressures up to 145 psi, or 10 bar. It concentrates suspended solids and solutes of molecular weights greater than 1,000. The permeate contains low-molecular weight organic solutes and salts. Ultrafiltration is widely used in the fractionation of milk and whey, and also finds application in protein fractionation.

Microfiltration is a low-pressure cross-flow membrane process for separating colloidal and suspended particles in the range of 0.05-10 microns. Microfiltration is typically used for fermentation broth clarification and biomass clarification and recovery.

### EXAMPLES

The following examples are illustrative of the present invention and are not intended to be limitations thereon. Unless otherwise specified, all percentages are based on 100% by volume of the sample.

### Example 1

At a paper coatings plant, various waste samples were taken from spills and “washdowns” after coating paper. The coatings consisted of latex, waxes, emulsions, formaldehyde and organic and inorganic pigments. The color of the waste stream was pink to red in apparent color.

The waste samples were treated with various concentrations of aluminum chloride solution and a cationic polymer-emulsion polyacrylamide with various degrees of charge. Various settling times for solids to settle to 50% of the original volume of the waste solution were observed. See Table 1 for specific concentrations used and settling times observed.

TABLE 1

| CATIONIC | | | |
|---|---|---|---|
| POLYMER- | | | |
| EMULSION | | | |
| POLY- | | | |
| ACRYLAMIDE, | | | |
| 40% DEGREE OF | | | SETTLING-TIME |
| CHARGE, | | COLOR- | FOR SOLIDS TO |
| 8 MILLION | ALUMINUM | PLATINUM | SETTLE TO 50% |
| MOLECULAR | CHLORIDE | COBALT | OF ORIGINAL |
| WEIGHT | DOSAGE | UNITS | VOLUME |
| 1 PPM | 1000 PPM | 5000+ | 7 MINUTES |
| 5 PPM | 1000 PPM | 5000+ | 7 MINUTES |
| 10 PPM | 1000 PPM | 5000+ | 5 MINUTES |
| 15 PPM | 1000 PPM | 5000+ | 5 MINUTES |
| 20 PPM | 1000 PPM | 5000+ | 3 MINUTES |
| 25 PPM | 1000 PPM | 5000+ | 3 MINUTES |
| 30 PPM | 1000 PPM | 5000+ | 2 MINUTES |
| 35 PPM | 1000 PPM | 5000+ | 2 MINUTES |
| 40 PPM | 1000 PPM | 5000+ | 45 SECONDS |
| 50 PPM | 1000 PPM | 5000+ | 30 SECONDS |
| 1 PPM | 2000 PPM | 5000+ | 7 MINUTES |
| 5 PPM | 2000 PPM | 5000+ | 7 MINUTES |
| 10 PPM | 2000 PPM | 5000+ | 5 MINUTES |
| 15 PPM | 2000 PPM | 5000+ | 5 MINUTES |
| 20 PPM | 2000 PPM | 5000+ | 3 MINUTES |
| 25 PPM | 2000 PPM | 5000+ | 3 MINUTES |
| 30 PPM | 2000 PPM | 5000+ | 2 MINUTES |
| 35 PPM | 2000 PPM | 5000+ | 2 MINUTES |
| 40 PPM | 2000 PPM | 5000+ | 45 SECONDS |
| 50 PPM | 2000 PPM | 5000+ | 30 SECONDS |
| 1 PPM | 3000 PPM | 5000+ | 2 MINUTES |
| 5 PPM | 3000 PPM | 5000+ | 2 MINUTES |
| 10 PPM | 3000 PPM | 5000+ | 2 MINUTES |
| 15 PPM | 3000 PPM | 5000+ | 1 MINUTES |
| 20 PPM | 3000 PPM | 5000+ | 1 MINUTES |
| 25 PPM | 3000 PPM | 5000+ | 45 SECONDS |
| 30 PPM | 3000 PPM | 5000+ | 30 SECONDS |
| 35 PPM | 3000 PPM | 5000+ | 25 SECONDS |
| 40 PPM | 3000 PPM | 5000+ | 20 SECONDS |
| 50 PPM | 3000 PPM | 5000+ | 20 SECONDS |
| 1 PPM | 4000 PPM | 5000+ | 3 MINUTES |
| 5 PPM | 4000 PPM | 5000+ | 3 MINUTES |
| 10 PPM | 4000 PPM | 5000+ | 2 MINUTES |
| 15 PPM | 4000 PPM | 5000+ | 2 MINUTES |
| 20 PPM | 4000 PPM | 5000+ | 1 MINUTES |
| 25 PPM | 4000 PPM | 5000+ | 1 MINUTES |
| 30 PPM | 4000 PPM | 5000+ | 45 SECONDS |
| 35 PPM | 4000 PPM | 5000+ | 45 SECONDS |
| 40 PPM | 4000 PPM | 5000+ | 30 SECONDS |
| 50 PPM | 4000 PPM | 5000+ | 20 SECONDS |
| 1 PPM | 5000 PPM | 5000+ | 3 MINUTES |
| 5 PPM | 5000 PPM | 5000+ | 3 MINUTES |
| 10 PPM | 5000 PPM | 5000+ | 3 MINUTES |
| 15 PPM | 5000 PPM | 5000+ | 2 MINUTES |
| 20 PPM | 5000 PPM | 5000+ | 2 MINUTES |
| 25 PPM | 5000 PPM | 5000+ | 1 ½ MINUTES |
| 30 PPM | 5000 PPM | 5000+ | 1 MINUTES |
| 35 PPM | 5000 PPM | 5000+ | 45 SECONDS |
| 40 PPM | 5000 PPM | 5000+ | 30 SECONDS |
| 50 PPM | 5000 PPM | 5000+ | 30 SECONDS |
| CATIONIC | | | |
| POLYMER- | | | |
| EMULSION | | | |
| POLY- | | | |
| ACRYLAMIDE, | | | |
| 80% DEGREE OF | | | SETTLING-TIME |
| CHARGE, | | COLOR- | FOR SOLIDS TO |
| 8 MILLION | | PLATINUM | SETTLE TO 50% |
| MOLECULAR | ALUMINUM | COBALT | OF ORIGINAL |
| WEIGHT | CHLORIDE | UNITS | VOLUME |
| 1 PPM | 1000 PPM | 5000+ | 3 MINUTES |
| 5 PPM | 1000 PPM | 5000+ | 3 MINUTES |
| 10 PPM | 1000 PPM | 5000+ | 3 MINUTES |
| 15 PPM | 1000 PPM | 5000+ | 2 MINUTES |
| 20 PPM | 1000 PPM | 5000+ | 2 MINUTES |
| 25 PPM | 1000 PPM | 5000+ | 1 ½ MINUTES |
| 30 PPM | 1000 PPM | 5000+ | 1 MINUTES |
| 35 PPM | 1000 PPM | 5000+ | 45 SECONDS |
| 40 PPM | 1000 PPM | 5000+ | 30 SECONDS |
| 50 PPM | 1000 PPM | 5000+ | 30 SECONDS |
| 1 PPM | 2000 PPM | 5000+ | 3 MINUTES |
| 5 PPM | 2000 PPM | 5000+ | 3 MINUTES |
| 10 PPM | 2000 PPM | 5000+ | 3 MINUTES |
| 15 PPM | 2000 PPM | 5000+ | 2 MINUTES |
| 20 PPM | 2000 PPM | 5000+ | 2 MINUTES |
| 25 PPM | 2000 PPM | 5000+ | 1 ½ MINUTES |
| 30 PPM | 2000 PPM | 5000+ | 1 MINUTES |
| 35 PPM | 2000 PPM | 5000+ | 45 SECONDS |
| 40 PPM | 2000 PPM | 5000+ | 30 SECONDS |
| 50 PPM | 2000 PPM | 5000+ | 30 SECONDS |
| 1 PPM | 3000 PPM | 5000+ | 3 MINUTES |
| 5 PPM | 3000 PPM | 5000+ | 3 MINUTES |
| 10 PPM | 3000 PPM | 5000+ | 3 MINUTES |
| 15 PPM | 3000 PPM | 5000+ | 2 MINUTES |
| 20 PPM | 3000 PPM | 5000+ | 2 MINUTES |
| 25 PPM | 3000 PPM | 5000+ | 1 ½ MINUTES |
| 30 PPM | 3000 PPM | 5000+ | 1 MINUTES |
| 35 PPM | 3000 PPM | 5000+ | 45 SECONDS |
| 40 PPM | 3000 PPM | 5000+ | 30 SECONDS |
| 50 PPM | 3000 PPM | 5000+ | 30 SECONDS |
| 1 PPM | 4000 PPM | 5000+ | 3 MINUTES |
| 5 PPM | 4000 PPM | 5000+ | 3 MINUTES |
| 10 PPM | 4000 PPM | 5000+ | 3 MINUTES |
| 15 PPM | 4000 PPM | 5000+ | 2 MINUTES |
| 20 PPM | 4000 PPM | 5000+ | 2 MINUTES |
| 25 PPM | 4000 PPM | 5000+ | 1 ½ MINUTES |
| 30 PPM | 4000 PPM | 5000+ | 1 MINUTES |
| 35 PPM | 4000 PPM | 5000+ | 45 SECONDS |
| 40 PPM | 4000 PPM | 5000+ | 30 SECONDS |
| 50 PPM | 4000 PPM | 5000+ | 30 SECONDS |
| 1 PPM | 5000 PPM | 5000+ | 3 MINUTES |
| 5 PPM | 5000 PPM | 5000+ | 3 MINUTES |
| 10 PPM | 5000 PPM | 5000+ | 3 MINUTES |
| 15 PPM | 5000 PPM | 5000+ | 2 MINUTES |
| 20 PPM | 5000 PPM | 5000+ | 2 MINUTES |
| 25 PPM | 5000 PPM | 5000+ | 1 ½ MINUTES |
| 30 PPM | 5000 PPM | 5000+ | 1 MINUTES |
| 35 PPM | 5000 PPM | 5000+ | 45 SECONDS |
| 40 PPM | 5000 PPM | 5000+ | 30 SECONDS |
| 50 PPM | 5000 PPM | 5000+ | 30 SECONDS |

### Example 2

At a paper coatings plant, various waste samples were taken from spills and “washdowns” after coating paper. The coatings consisted of latex, waxes, emulsions, formaldehyde and organic and inorganic pigments. The color of the waste stream was black in apparent color.

The waste samples were treated with various concentrations of aluminum chloride solution and cationic polyamine, as well as with different ratios of aluminum chloride to cationic polyamine. The resulting effect on color removal, based on the different concentrations and different ratios of aluminum chloride/polyamine can be seen in Table 2. The color of the effluent is measured in platinum-cobalt units.

TABLE 2

| ALUMINUM | | |
|---|---|---|
| CHLORIDE/POLYAMINE | | COLOR- |
| RATIO | DOSAGE | PLATINUM COBALT UNITS |
| 20/80 | 500 PPM | 400 |
| 30/70 | 500 PPM | 360 |
| 40/60 | 500 PPM | 400 |
| 50/50 | 500 PPM | 420 |
| 60/40 | 500 PPM | 340 |
| 70/30 | 500 PPM | 240 |
| 80/20 | 500 PPM | 720 |
| 20/80 | 1000 PPM | 300 |
| 30/70 | 1000 PPM | 430 |
| 40/60 | 1000 PPM | 640 |
| 50/50 | 1000 PPM | 700 |
| 60/40 | 1000 PPM | 300 |
| 70/30 | 1000 PPM | 420 |
| 80/20 | 1000 PPM | 500 |
| 20/80 | 1500 PPM | 330 |
| 30/70 | 1500 PPM | 460 |
| 40/60 | 1500 PPM | 640 |
| 50/50 | 1500 PPM | 720 |
| 60/40 | 1500 PPM | 348 |
| 70/30 | 1500 PPM | 437 |
| 80/20 | 1500 PPM | 556 |
| 20/80 | 2000 PPM | 440 |
| 30/70 | 2000 PPM | 370 |
| 40/60 | 2000 PPM | 330 |
| 50/50 | 2000 PPM | 300 |
| 60/40 | 2000 PPM | 380 |
| 70/30 | 2000 PPM | 420 |
| 80/20 | 2000 PPM | 540 |
| 20/80 | 2500 PPM | 447 |
| 30/70 | 2500 PPM | 382 |
| 40/60 | 2500 PPM | 330 |
| 50/50 | 2500 PPM | 300 |
| 60/40 | 2500 PPM | 386 |
| 70/30 | 2500 PPM | 426 |
| 80/20 | 2500 PPM | 548 |
| 20/80 | 3000 PPM | 300 |
| 30/70 | 3000 PPM | 320 |
| 40/60 | 3000 PPM | 330 |
| 50/50 | 3000 PPM | 360 |
| 60/40 | 3000 PPM | 370 |
| 70/30 | 3000 PPM | 620 |
| 80/20 | 3000 PPM | 700 |
| 20/80 | 3500 PPM | 310 |
| 30/70 | 3500 PPM | 327 |
| 40/60 | 3500 PPM | 346 |
| 50/50 | 3500 PPM | 359 |
| 60/40 | 3500 PPM | 365 |
| 70/30 | 3500 PPM | 624 |
| 80/20 | 3500 PPM | 700 |
| 20/80 | 4000 PPM | 3200 |
| 30/70 | 4000 PPM | 3000 |
| 40/60 | 4000 PPM | 700 |
| 50/50 | 4000 PPM | 500 |
| 60/40 | 4000 PPM | 720 |
| 70/30 | 4000 PPM | 900 |
| 80/20 | 4000 PPM | 2200 |
| 20/80 | 5000 PPM | 3400 |
| 30/70 | 5000 PPM | 1000 |
| 40/60 | 5000 PPM | 3000 |
| 50/50 | 5000 PPM | 5000+ |
| 60/40 | 5000 PPM | 4200 |
| 70/30 | 5000 PPM | 2000 |
| 80/20 | 5000 PPM | 3100 |

### Example 3

At a paper coatings plant, various waste samples were taken from spills and “washdowns” after coating paper. The coatings consisted of latex, waxes, emulsions, formaldehyde and organic and inorganic pigments.

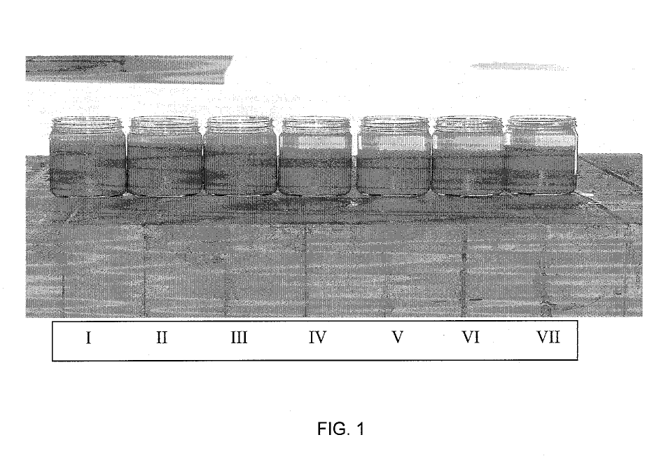

The waste samples were treated with 2000 ppm of various ratios of aluminum chloride solution and cationic polyamine. The quantitative results of treating samples I-VII are shown in Table 3 below. The qualitative results of treating samples I-VII are shown in FIG. 1.

TABLE 3

| | WASTE SAMPLE | | | | | | |
|---|---|---|---|---|---|---|---|
| | I | II | III | IV | V | VI | VII |
| ALUMINUM | 20/80 | 30/70 | 40/60 | 50/50 | 60/40 | 70/30 | 80/20 |
| CHLORIDE | | | | | | | |
| POLYAMINE | | | | | | | |
| RATIO | | | | | | | |
| DOSAGE | 2000 PPM | 2000 PPM | 2000 PPM | 2000 PPM | 2000 PPM | 2000 PPM | 2000 PPM |

### Example 4

At a paper coatings plant, various 1000 mL waste samples were taken from spills and “washdowns” after coating paper. The coatings consisted of latex, waxes, emulsions, formaldehyde and organic and inorganic pigments.

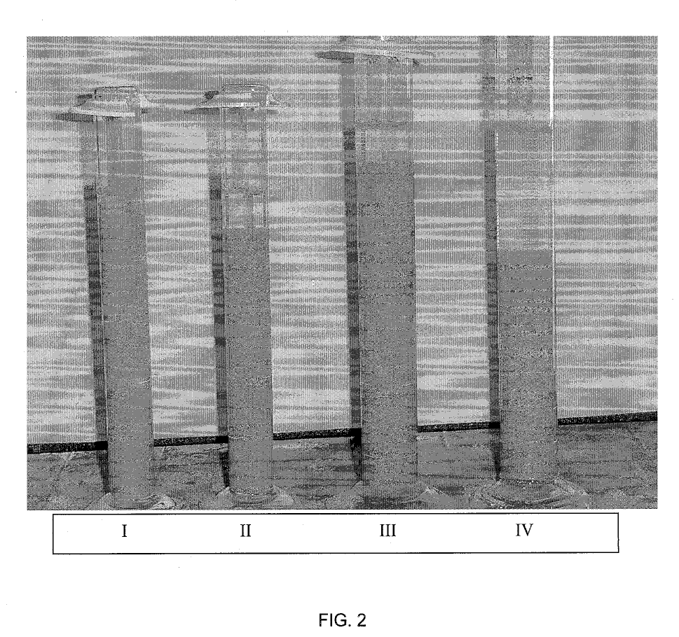

The waste samples were treated with 3000 ppm of a 1:1 ratio of aluminum chloride solution and cationic polyamine. Concentrations of 10, 20, 30 and 40 ppm of the cationic polymer at 80% degree of charge, 8 million molecular weight were added. The quantitative results of treating samples I-IV are shown in Table 4 below. The qualitative results of treating samples I-IV are shown in FIG. 2.

TABLE 4

| | WASTE SAMPLE | | | |
|---|---|---|---|---|
| | I | II | III | IV |
| POLYAMINE | 50/50 | 50/50 | 50/50 | 50/50 |
| ALUMINUM | | | | |
| CHLORIDE | | | | |
| RATIO | | | | |
| DOSAGE | 3000 PPM | 3000 PPM | 3000 PPM | 3000 PPM |
| CATIONIC POLYMER- | 10 PPM | 20 PPM | 30 PPM | 40 PPM |
| EMULSION | | | | |
| POLYACRYLAMIDE, | | | | |
| 80% DEGREE OF | | | | |
| CHARGE, 8 MILLION | | | | |
| MOLECULAR | | | | |
| WEIGHT | | | | |

### Example 5

At a paper coatings plant, various waste samples were taken from spills and “washdowns” after coating paper. The coatings consisted of latex, waxes, emulsions, formaldehyde and organic and inorganic pigments.

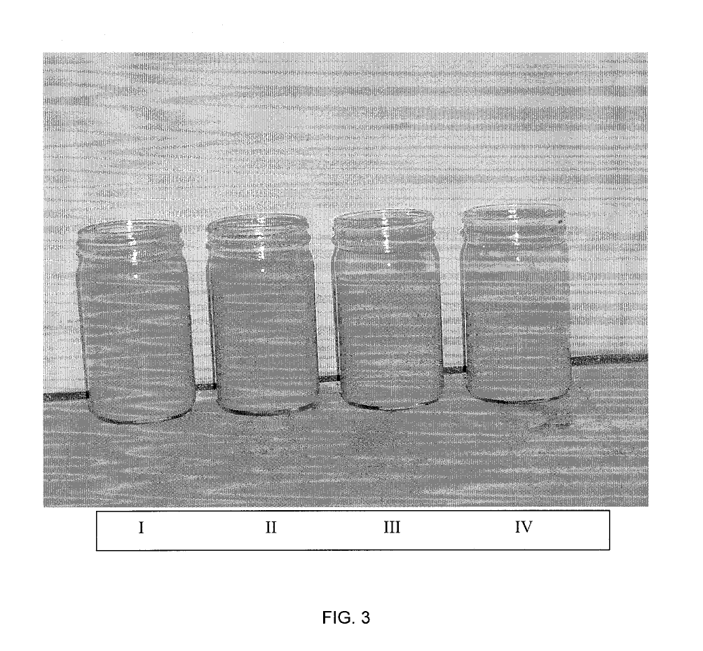

The waste samples were treated with various concentrations of a 1:1 ratio of aluminum chloride solution and cationic polyamine. A concentration of 30 ppm of the cationic polymer at 80% degree of charge, 8 million molecular weight was added. The quantitative results of treating samples I-IV are shown in Table 5 below. The qualitative results of treating samples I-IV are shown in FIG. 3.

TABLE 5

| | WASTE SAMPLE | | | |
|---|---|---|---|---|
| | I | II | III | IV |
| POLYAMINE | 50/50 | 50/50 | 50/50 | 50/50 |
| ALUMINUM | | | | |
| CHLORIDE | | | | |
| RATIO | | | | |
| DOSAGE | 1000 PPM | 2000 PPM | 3000 PPM | 4000 PPM |
| CATIONIC POLYMER- | 30 PPM | 30 PPM | 30 PPM | 30 PPM |
| EMULSION | | | | |
| POLYACRYLAMIDE, | | | | |
| 80% DEGREE OF | | | | |
| CHARGE, 8 MILLION | | | | |
| MOLECULAR | | | | |
| WEIGHT | | | | |

### Example 6

At a paper coatings plant, various waste samples were taken from spills and “washdowns” after coating paper. The coatings consisted of latex, waxes, emulsions, formaldehyde, organic and inorganic pigments and spills of undiluted coatings. The waste stream was black in apparent color.

The waste samples were treated with a 3000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. A concentration of 30 ppm of the cationic polymer-emulsion polyacrylamide at 80% degree of charge, 8 million molecular weight was then added to gather the colorant. The treated waste was then filtered with a JWI plate and frame filter press with a polypropylene screen. The sludge was gravity fed for approximately 20 minutes. Then, the pump applied approximately 20 psi to the sample through the filter for approximately 60 minutes. Then, the pump pressure was increased to 40 psi for approximately 60 minutes and then increased to 60 psi for the remaining time to process the sample.

The treatment cycle time was limited only by the flow rate through the filter press, with the effluent through the filter press free of solids. The resultant color (measured in platinum cobalt units) and filter cake quality observations are shown in Table 6 below.

TABLE 6

| | | CATIONIC POLYMER- | | |
|---|---|---|---|---|
| | | EMULSION POLY- | | |
| | POLYAMINE/ | ACRYLAMIDE, | COLOR- | FILTER |
| | ALUMINUM | 80% DEGREE | PLATINUM | PRESS |
| | CHLORIDE RATIO | OF CHARGE, 8 MILLION | COBALT | CAKE |
| | OF 50/50 | MOLECULAR WEIGHT | UNITS | QUALITY |
| DOSAGE | 3000 PPM | 30 PPM | 400 | DRY, |
| | | | | EASILY |
| | | | | REMOVED |
| | | | | FROM |
| | | | | SCREEN |

### Example 7

At a paper coatings plant, various waste samples were taken from spills and “washdowns” after coating paper. The coatings consisted of latex, waxes, emulsions, formaldehyde, organic and inorganic pigments and spills of undiluted coatings. The waste stream was green in apparent color.

The waste samples were treated with a 3000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. A concentration of 30 ppm of the cationic polymer-emulsion polyacrylamide at 80% degree of charge, 8 million molecular weight was then added to gather the colorant. The treated waste was then filtered with a JWI plate and frame filter press with a polypropylene screen. The sludge was gravity fed for approximately 20 minutes. Then, the pump applied approximately 20 psi to the sample through the filter for approximately 60 minutes. Then, the pump pressure was increased to 40 psi for approximately 60 minutes and then increased to 60 psi for the remaining time to process the sample.

The treatment cycle time was limited only by the flow rate through the filter press, with the effluent through the filter press free of solids. The resultant color (measured in platinum cobalt units) and filter cake quality observations are shown in Table 7 below.

TABLE 7

| | | CATIONIC POLYMER- | | |
|---|---|---|---|---|
| | | EMULSION POLY- | | |
| | POLYAMINE/ | ACRYLAMIDE, | COLOR- | FILTER |
| | ALUMINUM | 80% DEGREE | PLATINUM | PRESS |
| | CHLORIDE RATIO | OF CHARGE, 8 MILLION | COBALT | CAKE |
| | OF 50/50 | MOLECULAR WEIGHT | UNITS | QUALITY |
| DOSAGE | 3000 PPM | 30 PPM | 340 | DRY, |
| | | | | EASILY |
| | | | | REMOVED |
| | | | | FROM |
| | | | | SCREEN |

### Example 8

At a paper coatings plant, various waste samples were taken from spills and “washdowns” after coating paper. The coatings consisted of latex, waxes, emulsions, formaldehyde, organic and inorganic pigments and spills of undiluted coatings. The waste stream was beige in apparent color.

The waste samples were treated with a 3000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. A concentration of 30 ppm of the cationic polymer-emulsion polyacrylamide at 80% degree of charge, 8 million molecular weight was then added to gather the colorant. The treated waste was then filtered with a JWI plate and frame filter press with a polypropylene screen. The sludge was gravity fed for approximately 20 minutes. Then, the pump applied approximately 20 psi to the sample through the filter for approximately 60 minutes. Then, the pump pressure was increased to 40 psi for approximately 60 minutes and then increased to 60 psi for the remaining time to process the sample.

The treatment cycle time was limited only by the flow rate through the filter press, with the effluent through the filter press free of solids. The resultant color (measured in platinum cobalt units) and filter cake quality observations are shown in Table 8 below.

TABLE 8

| | | CATIONIC POLYMER- | | |
|---|---|---|---|---|
| | | EMULSION POLY- | | |
| | POLYAMINE/ | ACRYLAMIDE, | COLOR- | FILTER |
| | ALUMINUM | 80% DEGREE | PLATINUM | PRESS |
| | CHLORIDE RATIO | OF CHARGE, 8 MILLION | COBALT | CAKE |
| | OF 50/50 | MOLECULAR WEIGHT | UNITS | QUALITY |
| DOSAGE | 3000 PPM | 30 PPM | 160 | DRY, |
| | | | | EASILY |
| | | | | REMOVED |
| | | | | FROM |
| | | | | SCREEN |

### Example 9

At a paper coatings plant, various waste samples were taken from spills and “washdowns” after coating paper. The coatings consisted of latex, waxes, emulsions, formaldehyde, organic and inorganic pigments and spills of undiluted coatings. The waste stream was purple in apparent color.

The waste samples were treated with a 3000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. A concentration of 30 ppm of the cationic polymer-emulsion polyacrylamide at 80% degree of charge, 8 million molecular weight was then added to gather the colorant. The treated waste was then filtered with a JWI plate and frame filter press with a polypropylene screen. The sludge was gravity fed for approximately 20 minutes. Then, the pump applied approximately 20 psi to the sample through the filter for approximately 60 minutes. Then, the pump pressure was increased to 40 psi for approximately 60 minutes and then increased to 60 psi for the remaining time to process the sample.

The treatment cycle time was limited only by the flow rate through the filter press, with the effluent through the filter press free of solids. The resultant color (measured in platinum cobalt units) and filter cake quality observations are shown in Table 9 below.

TABLE 9

| | | CATIONIC POLYMER- | | |
|---|---|---|---|---|
| | | EMULSION POLY- | | |
| | POLYAMINE/ | ACRYLAMIDE, | COLOR- | FILTER |
| | ALUMINUM | 80% DEGREE | PLATINUM | PRESS |
| | CHLORIDE RATIO | OF CHARGE, 8 MILLION | COBALT | CAKE |
| | OF 50/50 | MOLECULAR WEIGHT | UNITS | QUALITY |
| DOSAGE | 3000 PPM | 30 PPM | 320 | DRY, |
| | | | | EASILY |
| | | | | REMOVED |
| | | | | FROM |
| | | | | SCREEN |

### Example 10

At a paper coatings plant, various waste samples were taken from spills and “washdowns” after coating paper. The coatings consisted of latex, waxes, emulsions, formaldehyde, organic and inorganic pigments and spills of undiluted coatings. The waste stream was black in apparent color.

The waste samples were treated with a 3000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. A concentration of 30 ppm of the cationic polymer-emulsion polyacrylamide at 80% degree of charge, 8 million molecular weight was then added to gather the colorant. The treated waste was then filtered with a JWI plate and frame filter press with a polypropylene screen. The sludge was gravity fed for approximately 20 minutes. Then, the pump applied approximately 20 psi to the sample through the filter for approximately 60 minutes. Then, the pump pressure was increased to 40 psi for approximately 60 minutes and then increased to 60 psi for the remaining time to process the sample.

The treatment cycle time was limited only by the flow rate through the filter press, with the effluent through the filter press free of solids. The resultant color (measured in platinum cobalt units) and filter cake quality observations are shown in Table 10 below.

TABLE 10

| | | CATIONIC POLYMER- | | |
|---|---|---|---|---|
| | | EMULSION POLY- | | |
| | POLYAMINE/ | ACRYLAMIDE, | COLOR- | FILTER |
| | ALUMINUM | 80% DEGREE | PLATINUM | PRESS |
| | CHLORIDE RATIO | OF CHARGE, 8 MILLION | COBALT | CAKE |
| | OF 50/50 | MOLECULAR WEIGHT | UNITS | QUALITY |
| DOSAGE | 3000 PPM | 30 PPM | 30 | DRY, |
| | | | | EASILY |
| | | | | REMOVED |
| | | | | FROM |
| | | | | SCREEN |

### Example 11

At a paper coatings plant, various waste samples were taken from spills and “washdowns” after coating paper. The coatings consisted of latex, waxes, emulsions, formaldehyde, organic and inorganic pigments and spills of undiluted coatings. The waste stream was black in apparent color.

The waste samples were treated with a 3000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. A concentration of 30 ppm of the cationic polymer-emulsion polyacrylamide at 80% degree of charge, 8 million molecular weight was then added to gather the colorant. The treated waste was then filtered with a JWI plate and frame filter press with a polypropylene screen. The sludge was gravity fed for approximately 20 minutes. Then, the pump applied approximately 20 psi to the sample through the filter for approximately 60 minutes. Then, the pump pressure was increased to 40 psi for approximately 60 minutes and then increased to 60 psi for the remaining time to process the sample.

The treatment cycle time was limited only by the flow rate through the filter press, with the effluent through the filter press free of solids. The resultant color (measured in platinum cobalt units) and filter cake quality observations are shown in Table 11 below.

TABLE 11

| | | CATIONIC POLYMER- | | |
|---|---|---|---|---|
| | | EMULSION POLY- | | |
| | POLYAMINE/ | ACRYLAMIDE, | COLOR- | FILTER |
| | ALUMINUM | 80% DEGREE | PLATINUM | PRESS |
| | CHLORIDE RATIO | OF CHARGE, 8 MILLION | COBALT | CAKE |
| | OF 50/50 | MOLECULAR WEIGHT | UNITS | QUALITY |
| DOSAGE | 3000 PPM | 30 PPM | 60 | DRY, |
| | | | | EASILY |
| | | | | REMOVED |
| | | | | FROM |
| | | | | SCREEN |

### Example 12

At a paper coatings plant, various waste samples were taken from spills and “washdowns” after coating paper. The coatings consisted of latex, waxes, emulsions, formaldehyde, organic and inorganic pigments and spills of undiluted coatings. The waste stream was pink in apparent color.

The waste samples were treated with a 3000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. A concentration of 30 ppm of the cationic polymer-emulsion polyacrylamide at 80% degree of charge, 8 million molecular weight was then added to gather the colorant. The treated waste was then filtered with a JWI plate and frame filter press with a polypropylene screen. The sludge was gravity fed for approximately 20 minutes. Then, the pump applied approximately 20 psi to the sample through the filter for approximately 60 minutes. Then, the pump pressure was increased to 40 psi for approximately 60 minutes and then increased to 60 psi for the remaining time to process the sample.

The treatment cycle time was limited only by the flow rate through the filter press, with the effluent through the filter press free of solids. The resultant color (measured in platinum cobalt units) and filter cake quality observations are shown in Table 12 below.

TABLE 12

| | | CATIONIC | | |
|---|---|---|---|---|
| | | POLYMER-EMULSION | | |
| | | POLYACRYLAMLDE, | | |
| | POLYAMINE/ | 80% DEGREE | COLOR- | FILTER |
| | ALUMINUM | OF CHARGE, 8 | PLATINUM | PRESS |
| | CHLORIDE RATIO | MILLION | COBALT | CAKE |
| | OF 50/50 | MOLECULAR WEIGHT | UNITS | QUALITY |
| DOSAGE | 3000 PPM | 30 PPM | 70 | DRY, |
| | | | | EASILY |
| | | | | REMOVED |
| | | | | FROM |
| | | | | SCREEN |

### Example 13

At a paper coatings plant, various waste samples were taken from spills and “washdowns” after coating paper. The coatings consisted of latex, waxes, emulsions, formaldehyde, organic and inorganic pigments and spills of undiluted coatings. The waste stream was dark blue to black in apparent color.

The waste samples were treated with a 3000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. A concentration of 30 ppm of the cationic polymer-emulsion polyacrylamide at 80% degree of charge, 8 million molecular weight was then added to gather the colorant. The treated waste was then filtered with a JWI plate and frame filter press with a polypropylene screen. The sludge was gravity fed for approximately 20 minutes. Then, the pump applied approximately 20 psi to the sample through the filter for approximately 60 minutes. Then, the pump pressure was increased to 40 psi for approximately 60 minutes and then increased to 60 psi for the remaining time to process the sample.

The treatment cycle time was limited only by the flow rate through the filter press, with the effluent through the filter press free of solids. The resultant color (measured in platinum cobalt units) and filter cake quality observations are shown in Table 13 below.

TABLE 13

| | | CATIONIC | | |
|---|---|---|---|---|
| | | POLYMER-EMULSION | | |
| | | POLYACRYLAMLDE, | | |
| | POLYAMINE/ | 80% DEGREE | COLOR- | FILTER |
| | ALUMINUM | OF CHARGE, 8 | PLATINUM | PRESS |
| | CHLORIDE RATIO | MILLION | COBALT | CAKE |
| | OF 50/50 | MOLECULAR WEIGHT | UNITS | QUALITY |
| DOSAGE | 3000 PPM | 30 PPM | 30 | DRY, |
| | | | | EASILY |
| | | | | REMOVED |
| | | | | FROM |
| | | | | SCREEN |

### Example 14

At a paper coatings plant, various waste samples were taken from spills and “washdowns” after coating paper. The coatings consisted of latex, waxes, emulsions, formaldehyde, organic and inorganic pigments and spills of undiluted coatings. The waste stream was red in apparent color.

The waste samples were treated with a 3000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. A concentration of 30 ppm of the cationic polymer-emulsion polyacrylamide at 80% degree of charge, 8 million molecular weight was then added to gather the colorant. The treated waste was then filtered with a JWI plate and frame filter press with a polypropylene screen. The sludge was gravity fed for approximately 20 minutes. Then, the pump applied approximately 20 psi to the sample through the filter for approximately 60 minutes. Then, the pump pressure was increased to 40 psi for approximately 60 minutes and then increased to 60 psi for the remaining time to process the sample.

The treatment cycle time was limited only by the flow rate through the filter press, with the effluent through the filter press free of solids. The resultant color (measured in platinum cobalt units) and filter cake quality observations are shown in Table 14 below.

TABLE 14

| | | CATIONIC | | |
|---|---|---|---|---|
| | | POLYMER-EMULSION | | |
| | | POLYACRYLAMLDE, | | |
| | POLYAMINE/ | 80% DEGREE | COLOR- | FILTER |
| | ALUMINUM | OF CHARGE, 8 | PLATINUM | PRESS |
| | CHLORIDE RATIO | MILLION | COBALT | CAKE |
| | OF 50/50 | MOLECULAR WEIGHT | UNITS | QUALITY |
| DOSAGE | 3000 PPM | 30 PPM | 40 | DRY, |
| | | | | EASILY |
| | | | | REMOVED |
| | | | | FROM |
| | | | | SCREEN |

### Example 15

At a paper coatings plant, various waste samples were taken from spills and “washdowns” after coating paper. The coatings consisted of latex, waxes, emulsions, formaldehyde, organic and inorganic pigments and spills of undiluted coatings. The waste stream was black in apparent color.

The waste samples were treated with a 3000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. A concentration of 30 ppm of the cationic polymer-emulsion polyacrylamide at 80% degree of charge, 8 million molecular weight was then added to gather the colorant. The treated waste was then filtered with a JWI plate and frame filter press with a polypropylene screen. The sludge was gravity fed for approximately 20 minutes. Then, the pump applied approximately 20 psi to the sample through the filter for approximately 60 minutes. Then, the pump pressure was increased to 40 psi for approximately 60 minutes and then increased to 60 psi for the remaining time to process the sample.

The treatment cycle time was limited only by the flow rate through the filter press, with the effluent through the filter press free of solids. The resultant color (measured in platinum cobalt units) and filter cake quality observations are shown in Table 15 below.

TABLE 15

| | | CATIONIC | | |
|---|---|---|---|---|
| | | POLYMER-EMULSION | | |
| | | POLYACRYLAMLDE, | | |
| | POLYAMINE/ | 80% DEGREE | COLOR- | FILTER |
| | ALUMINUM | OF CHARGE, 8 | PLATINUM | PRESS |
| | CHLORIDE RATIO | MILLION | COBALT | CAKE |
| | OF 50/50 | MOLECULAR WEIGHT | UNITS | QUALITY |
| DOSAGE | 3000 PPM | 30 PPM | 10 | DRY, |
| | | | | EASILY |
| | | | | REMOVED |
| | | | | FROM |
| | | | | SCREEN |

### Example 16

At a paper coatings plant, various waste samples were taken from spills and “washdowns” after coating paper. The coatings consisted of latex, waxes, emulsions, formaldehyde, organic and inorganic pigments and spills of undiluted coatings. The waste stream was blue green in apparent color.

The waste samples were treated with a 3000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. A concentration of 30 ppm of the cationic polymer-emulsion polyacrylamide at 80% degree of charge, 8 million molecular weight was then added to gather the colorant. The treated waste was then filtered with a JWI plate and frame filter press with a polypropylene screen. The sludge was gravity fed for approximately 20 minutes. Then, the pump applied approximately 20 psi to the sample through the filter for approximately 60 minutes. Then, the pump pressure was increased to 40 psi for approximately 60 minutes and then increased to 60 psi for the remaining time to process the sample.

The treatment cycle time was limited only by the flow rate through the filter press, with the effluent through the filter press free of solids. The resultant color (measured in platinum cobalt units) and filter cake quality observations are shown in Table 16 below.

TABLE 16

| | | CATIONIC | | |
|---|---|---|---|---|
| | | POLYMER-EMULSION | | |
| | | POLYACRYLAMLDE, | | |
| | POLYAMINE/ | 80% DEGREE | COLOR- | FILTER |
| | ALUMINUM | OF CHARGE, 8 | PLATINUM | PRESS |
| | CHLORIDE RATIO | MILLION | COBALT | CAKE |
| | OF 50/50 | MOLECULAR WEIGHT | UNITS | QUALITY |
| DOSAGE | 3000 PPM | 30 PPM | 100 | DRY, |
| | | | | EASILY |
| | | | | REMOVED |
| | | | | FROM |
| | | | | SCREEN |

### Example 17

At a paper coatings plant, various waste samples were taken from spills and “washdowns” after coating paper. The coatings consisted of latex, waxes, emulsions, formaldehyde, organic and inorganic pigments and spills of undiluted coatings. The waste stream was light purple in apparent color.

The waste samples were treated with a 3000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. A concentration of 30 ppm of the cationic polymer-emulsion polyacrylamide at 80% degree of charge, 8 million molecular weight was then added to gather the colorant. The treated waste was then filtered with a JWI plate and frame filter press with a polypropylene screen. The sludge was gravity fed for approximately 20 minutes. Then, the pump applied approximately 20 psi to the sample through the filter for approximately 60 minutes. Then, the pump pressure was increased to 40 psi for approximately 60 minutes and then increased to 60 psi for the remaining time to process the sample.

The treatment cycle time was limited only by the flow rate through the filter press, with the effluent through the filter press free of solids. The resultant color (measured in platinum cobalt units) and filter cake quality observations are shown in Table 17 below.

TABLE 17

| | | CATIONIC | | |
|---|---|---|---|---|
| | | POLYMER-EMULSION | | |
| | | POLYACRYLAMLDE, | | |
| | POLYAMINE/ | 80% DEGREE | COLOR- | FILTER |
| | ALUMINUM | OF CHARGE, 8 | PLATINUM | PRESS |
| | CHLORIDE RATIO | MILLION | COBALT | CAKE |
| | OF 50/50 | MOLECULAR WEIGHT | UNITS | QUALITY |
| DOSAGE | 3000 PPM | 30 PPM | 60 | DRY, |
| | | | | EASILY |
| | | | | REMOVED |
| | | | | FROM |
| | | | | SCREEN |

### Example 18

At a paper coatings plant, various waste samples were taken from spills and “washdowns” after coating paper. The coatings consisted of latex, waxes, emulsions, formaldehyde, organic and inorganic pigments and spills of undiluted coatings. The waste stream was black in apparent color.

The waste samples were treated with a 3000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. A concentration of 30 ppm of the cationic polymer-emulsion polyacrylamide at 80% degree of charge, 8 million molecular weight was then added to gather the colorant. The treated waste was then filtered with a JWI plate and frame filter press with a polypropylene screen. The sludge was gravity fed for approximately 20 minutes. Then, the pump applied approximately 20 psi to the sample through the filter for approximately 60 minutes. Then, the pump pressure was increased to 40 psi for approximately 60 minutes and then increased to 60 psi for the remaining time to process the sample.

The treatment cycle time was limited only by the flow rate through the filter press, with the effluent through the filter press free of solids. The resultant color (measured in platinum cobalt units) and filter cake quality observations are shown in Table 18 below. Before treatment (I) and after treatment (II) qualitative results of this experiment can be seen in FIG. 4.

TABLE 18

| | | CATIONIC | | |
|---|---|---|---|---|
| | | POLYMER-EMULSION | | |
| | | POLYACRYLAMLDE, | | |
| | POLYAMINE/ | 80% DEGREE | COLOR- | FILTER |
| | ALUMINUM | OF CHARGE, 8 | PLATINUM | PRESS |
| | CHLORIDE RATIO | MILLION | COBALT | CAKE |
| | OF 50/50 | MOLECULAR WEIGHT | UNITS | QUALITY |
| DOSAGE | 3000 PPM | 30 PPM | 50 | DRY, |
| | | | | EASILY |
| | | | | REMOVED |
| | | | | FROM |
| | | | | SCREEN |

### Example 19

At an ink and coating manufacturing plant, both organic and inorganic coatings and inks are produced. Waste is generated by the “washdowns” of tanks between process changes and “washdowns” of floor spills. Both color concentration and solids levels vary greatly as components of the waste stream.

The waste samples were treated with various concentrations of aluminum chloride solution and cationic polyamines, as well as with different ratios of aluminum chloride to cationic polyamine. The resulting effect on color removal, based on the different concentrations and different ratios of aluminum chloride/polyamine can be seen in Table 19. The color of the effluent is measured in platinum-cobalt units.

TABLE 19

| ALUMINUM | | |
|---|---|---|
| CHLORIDE/POLYAMINE | | COLOR- |
| RATIO | DOSAGE | PLATINUM COBALT UNITS |
| 20/80 | 1000 PPM | 1000 |
| 30/70 | 1000 PPM | 578 |
| 40/60 | 1000 PPM | 497 |
| 50/50 | 1000 PPM | 359 |
| 60/40 | 1000 PPM | 300 |
| 70/30 | 1000 PPM | 240 |
| 80/20 | 1000 PPM | 200 |
| 20/80 | 1500 PPM | 2578 |
| 30/70 | 1500 PPM | 489 |
| 40/60 | 1500 PPM | 679 |
| 50/50 | 1500 PPM | 300 |
| 60/40 | 1500 PPM | 348 |
| 70/30 | 1500 PPM | 473 |
| 80/20 | 1500 PPM | 606 |
| 20/80 | 2000 PPM | 357 |
| 30/70 | 2000 PPM | 303 |
| 40/60 | 2000 PPM | 257 |
| 50/50 | 2000 PPM | 245 |
| 60/40 | 2000 PPM | 279 |
| 70/30 | 2000 PPM | 327 |
| 80/20 | 2000 PPM | 319 |
| 20/80 | 2500 PPM | 257 |
| 30/70 | 2500 PPM | 203 |
| 40/60 | 2500 PPM | 157 |
| 50/50 | 2500 PPM | 145 |
| 60/40 | 2500 PPM | 179 |
| 70/30 | 2500 PPM | 197 |
| 80/20 | 2500 PPM | 197 |
| 20/80 | 3000 PPM | 247 |
| 30/70 | 3000 PPM | 243 |
| 40/60 | 3000 PPM | 176 |
| 50/50 | 3000 PPM | 100 |
| 60/40 | 3000 PPM | 104 |
| 70/30 | 3000 PPM | 100 |
| 80/20 | 3000 PPM | 159 |
| 20/80 | 3500 PPM | 367 |
| 30/70 | 3500 PPM | 443 |
| 40/60 | 3500 PPM | 286 |
| 50/50 | 3500 PPM | 100 |
| 60/40 | 3500 PPM | 124 |
| 70/30 | 3500 PPM | 127 |
| 80/20 | 3500 PPM | 189 |
| 20/80 | 4000 PPM | 267 |
| 30/70 | 4000 PPM | 263 |
| 40/60 | 4000 PPM | 196 |
| 50/50 | 4000 PPM | 120 |
| 60/40 | 4000 PPM | 144 |
| 70/30 | 4000 PPM | 160 |
| 80/20 | 4000 PPM | 189 |
| 20/80 | 5000 PPM | 407 |
| 30/70 | 5000 PPM | 363 |
| 40/60 | 5000 PPM | 176 |
| 50/50 | 5000 PPM | 308 |
| 60/40 | 5000 PPM | 424 |
| 70/30 | 5000 PPM | 467 |
| 80/20 | 5000 PPM | 198 |

### Example 20

At an ink and coating manufacturing plant, both organic and inorganic coatings and inks are produced. Waste is generated by the “washdowns” of tanks between process changes and “washdowns” of floor spills. Both color concentration and solids levels vary greatly as components of the waste stream.

The waste samples were treated with 3000 ppm of 1:1 aluminum chloride solution and cationic polyamine to break the colorant from the waste solution. The waste samples were then treated with various concentrations of cationic polymer-emulsion polyacrylamide at 80% degree of charge, 8 million molecular weight to gather the colorant. The resulting effect on color removal, based on the different concentrations of the cationic polymer-emulsion polyacrylamide can be seen in Table 20. The color of the effluent is measured in platinum-cobalt units. The settling time for the solids to settle to 50% of the original volume is also disclosed.

TABLE 20

| | | | | |
|---|---|---|---|---|
| POLYAMINE | 50/50 | 50/50 | 50/50 | 50/50 |
| ALUMINUM | | | | |
| CHLORIDE | | | | |
| RATIO | | | | |
| DOSAGE | 3000 PPM | 3000 PPM | 3000 PPM | 3000 PPM |
| CATIONIC | 1 PPM | 5 PPM | 10 PPM | 15 PPM |
| POLYMER- | | | | |
| EMULSION | | | | |
| POLYACRYLAMIDE, | | | | |
| 80% DEGREE OF | | | | |
| CHARGE,8 MILLION | | | | |
| MOLECULAR | | | | |
| WEIGHT | | | | |
| COLOR-PLATINUM | 79 | 103 | 100 | 200 |
| COBALT UNITS | | | | |
| SETTLING-TIME | 5 MINUTES | 30 SECONDS | 20 SECONDS | 20 SECONDS |
| FOR SOLIDS TO | | | | |
| SETTLE 50% OF | | | | |
| ORIGINAL VOLUME | | | | |

### Example 21

At an ink and coating manufacturing plant, both organic and inorganic coatings 20 and inks are produced. Waste is generated by the “washdowns” of tanks between process changes and “washdowns” of floor spills. Both color concentration and solids levels vary greatly as components of the waste stream. The coatings consisted of latex, waxes, emulsions, formaldehyde, organic and inorganic pigments and spills of undiluted coatings. The waste stream was black in apparent color.

The waste samples were treated with a 3000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. A concentration of 3 ppm of the cationic polymer-emulsion polyacrylamide at 80% degree of charge, 8 million molecular weight was then added to gather the colorant. The treated waste was then filtered with a JWI plate and frame filter press with a polypropylene screen covered with a satin-finish cloth filter. The sludge was gravity fed for approximately 20 minutes. Then, the pump applied approximately 20 psi to the sample through the filter for approximately 60 minutes. Then, the pump pressure was increased to 40 psi for approximately 60 minutes and then increased to 60 psi for the remaining time to process the sample.

The treatment cycle time was limited only by the flow rate through the filter press, with the effluent through the filter press free of solids. The resultant effluent color (measured in platinum cobalt units) and filter cake quality observations are shown in Table 21 below.

TABLE 21

| | | CATIONIC | | |
|---|---|---|---|---|
| | | POLYMER-EMULSION | | |
| | | POLYACRYLAMLDE, | | |
| | POLYAMINE/ | 80% DEGREE | COLOR- | FILTER |
| | ALUMINUM | OF CHARGE, 8 | PLATINUM | PRESS |
| | CHLORIDE RATIO | MILLION | COBALT | CAKE |
| | OF 50/50 | MOLECULAR WEIGHT | UNITS | QUALITY |
| DOSAGE | 3000 PPM | 3 PPM | 48 | DRY, |
| | | | | EASILY |
| | | | | REMOVED |
| | | | | FROM |
| | | | | CLOTH |

### Example 22

At an ink and coating manufacturing plant, both organic and inorganic coatings and inks are produced. Waste is generated by the “washdowns” of tanks between process changes and “washdowns” of floor spills. Both color concentration and solids levels vary greatly as components of the waste stream. The coatings consisted of latex, waxes, emulsions, formaldehyde, organic and inorganic pigments and spills of undiluted coatings. The waste stream was light blue in apparent color.

The waste samples were treated With a 3000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. A concentration of 3 ppm of the cationic polymer-emulsion polyacrylamide at 80% degree of charge, 8 million molecular weight was then added to gather the colorant. The treated waste was then filtered with a a JWI plate and frame filter press with a polypropylene screen covered with a satin-finish cloth filter. The sludge was gravity fed for approximately 20 minutes. Then, the pump applied approximately 20 psi to the sample through the filter for approximately 60 minutes. Then, the pump pressure was increased to 40 psi for approximately 60 minutes and then increased to 60 psi for the remaining time to process the sample.

The treatment cycle time was limited only by the flow rate through the filter press, with the effluent through the filter press free of solids. The resultant effluent color (measured in platinum cobalt units)n and filter cake quality observations are shown in Table 22 below.

TABLE 22

| | | CATIONIC | | |
|---|---|---|---|---|
| | | POLYMER-EMULSION | | |
| | POLYAMINE/ | POLYACRYLAMIDE, | COLOR- | FILTER |
| | ALUMINUM | 80% DEGREE OF | PLATINUM | PRESS |
| | CHLORIDE RATIO | CHARGE, 8 MILLION | COBALT | CAKE |
| | OF 50/50 | MOLECULAR WEIGHT | UNITS | QUALITY |
| DOSAGE | 3000 PPM | 3 PPM | 76 | DRY, |
| | | | | EASILY |
| | | | | REMOVED |
| | | | | FROM |
| | | | | CLOTH |

### Example 23

At an ink and coating manufacturing plant, both organic and inorganic coatings and inks are produced. Waste is generated by the “washdowns” of tanks between process changes and “washdowns” of floor spills. Both color concentration and solids levels vary greatly as components of the waste stream. The coatings consisted of latex, waxes, emulsions, formaldehyde, organic and inorganic pigments and spills of undiluted coatings. The waste stream was green in apparent color.

The waste samples were treated with a 3000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. A concentration of 3 ppm of the cationic polymer-emulsion polyacrylamide at 80% degree of charge, 8 million molecular weight was then added to gather the colorant. The treated waste was then filtered with a JWI plate and frame filter press with a polypropylene screen covered with a satin-finish cloth filter. The sludge was gravity fed for approximately 20 minutes. Then, the pump applied approximately 20 psi to the sample through the filter for approximately 60 minutes. Then, the pump pressure was increased to 40 psi for approximately 60 minutes and then increased to 60 psi for the remaining time to process the sample.

The treatment cycle time was limited only by the flow rate through the filter press, with the effluent through the filter press free of solids. The resultant effluent color (measured in platinum cobalt units) and filter cake quality observations are shown in Table 23 below.

TABLE 23

| | | CATIONIC | | |
|---|---|---|---|---|
| | | POLYMER-EMULSION | | |
| | POLYAMINE/ | POLYACRYLAMIDE, | COLOR- | FILTER |
| | ALUMINUM | 80% DEGREE OF | PLATINUM | PRESS |
| | CHLORIDE RATIO | CHARGE, 8 MILLION | COBALT | CAKE |
| | OF 50/50 | MOLECULAR WEIGHT | UNITS | QUALITY |
| DOSAGE | 3000 PPM | 3 PPM | 70 | DRY, |
| | | | | EASILY |
| | | | | REMOVED |
| | | | | FROM |
| | | | | CLOTH |

### Example 24

At an ink and coating manufacturing plant, both organic and inorganic coatings and inks are produced. Waste is generated by the “washdowns” of tanks between process changes and “washdowns” of floor spills. Both color concentration and solids levels vary greatly as components of the waste stream. The coatings consisted of latex, waxes, emulsions, formaldehyde, organic and inorganic pigments and spills of undiluted coatings. The waste stream was black in apparent color.

The waste samples were treated with a 3000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. A concentration of 3 ppm of the cationic polymer-emulsion polyacrylamide at 80% degree of charge, 8 million molecular weight was then added to gather the colorant. The treated waste was then filtered with a JWI plate and frame filter press with a polypropylene screen covered with a satin-finish cloth filter. The sludge was gravity fed for approximately 20 minutes. Then, the pump applied approximately 20 psi to the sample through the filter for approximately 60 minutes. Then, the pump pressure was increased to 40 psi for approximately 60 minutes and then increased to 60 psi for the remaining time to process the sample.

The treatment cycle time was limited only by the flow rate through the filter press, with the effluent through the filter press free of solids. The resultant effluent color (measured in platinum cobalt units) and filter cake quality observations are shown in Table 24 below.

TABLE 24

| | | CATIONIC | | |
|---|---|---|---|---|
| | | POLYMER-EMULSION | | |
| | POLYAMINE/ | POLYACRYLAMIDE, | COLOR- | FILTER |
| | ALUMINUM | 80% DEGREE OF | PLATINUM | PRESS |
| | CHLORIDE RATIO | CHARGE, 8 MILLION | COBALT | CAKE |
| | OF 50/50 | MOLECULAR WEIGHT | UNITS | QUALITY |
| DOSAGE | 3000 PPM | 3 PPM | 86 | DRY, |
| | | | | EASILY |
| | | | | REMOVED |
| | | | | FROM |
| | | | | CLOTH |

### Example 25

At an ink and coating manufacturing plant, both organic and inorganic coatings and inks are produced. Waste is generated by the “washdowns” of tanks between process changes and “washdowns” of floor spills. Both color concentration and solids levels vary greatly as components of the waste stream. The coatings consisted of latex, waxes, emulsions, formaldehyde, organic and inorganic pigments and spills of undiluted coatings. The waste stream was blue in apparent color.

The waste samples were treated with a 3000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. A concentration of 3 ppm of the cationic polymer-emulsion polyacrylamide at 80% degree of charge, 8 million molecular weight was then added to gather the colorant. The treated waste was then filtered with a JWI plate and frame filter press with a polypropylene screen covered with a satin-finish cloth filter. The sludge was gravity fed for approximately 20 minutes. Then, the pump applied approximately 20 psi to the sample through the filter for approximately 60 minutes. Then, the pump pressure was increased to 40 psi for approximately 60 minutes and then increased to 60 psi for the remaining time to process the sample.

The treatment cycle time was limited only by the flow rate through the filter press, with the effluent through the filter press free of solids. The resultant effluent color (measured in platinum cobalt units) and filter cake quality observations are shown in Table 25 below.

TABLE 25

| | | CATIONIC | | |
|---|---|---|---|---|
| | | POLYMER-EMULSION | | |
| | POLYAMINE/ | POLYACRYLAMIDE, | COLOR- | FILTER |
| | ALUMINUM | 80% DEGREE OF | PLATINUM | PRESS |
| | CHLORIDE RATIO | CHARGE, 8 MILLION | COBALT | CAKE |
| | OF 50/50 | MOLECULAR WEIGHT | UNITS | QUALITY |
| DOSAGE | 3000 PPM | 3 PPM | 34 | DRY, |
| | | | | EASILY |
| | | | | REMOVED |
| | | | | FROM |
| | | | | CLOTH |

### Example 26

At an ink and coating manufacturing plant, both organic and inorganic coatings and inks are produced. Waste is generated by the “washdowns” of tanks between process changes and “washdowns” of floor spills. Both color concentration and solids levels vary greatly as components of the waste stream. The coatings consisted of latex, waxes, emulsions, formaldehyde, organic and inorganic pigments and spills of undiluted coatings. The waste stream was black in apparent color.

The waste samples were treated with a 3000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. A concentration of 3 ppm of the cationic polymer-emulsion polyacrylamide at 80% degree of charge, 8 million molecular weight was then added to gather the colorant. The treated waste was then filtered with a JWI plate and frame filter press with a polypropylene screen covered with a satin-finish cloth filter. The sludge was gravity fed for approximately 20 minutes. Then, the pump applied approximately 20 psi to the sample through the filter for approximately 60 minutes. Then, the pump pressure was increased to 40 psi for approximately 60 minutes and then increased to 60 psi for the remaining time to process the sample.

The treatment cycle time was limited only by the flow rate through the filter press, with the effluent through the filter press free of solids. The resultant effluent color (measured in platinum cobalt units) and filter cake quality observations are shown in Table 26 below.

TABLE 26

| | | CATIONIC | | |
|---|---|---|---|---|
| | | POLYMER-EMULSION | | |
| | POLYAMINE/ | POLYACRYLAMIDE, | COLOR- | FILTER |
| | ALUMINUM | 80% DEGREE OF | PLATINUM | PRESS |
| | CHLORIDE RATIO | CHARGE, 8 MILLION | COBALT | CAKE |
| | OF 50/50 | MOLECULAR WEIGHT | UNITS | QUALITY |
| DOSAGE | 3000 PPM | 3 PPM | 40 | DRY, |
| | | | | EASILY |
| | | | | REMOVED |
| | | | | FROM |
| | | | | CLOTH |

### Example 27

At an ink and coating manufacturing plant, both organic and inorganic coatings and inks are produced. Waste is generated by the “washdowns” of tanks between process changes and “washdowns” of floor spills. Both color concentration and solids levels vary greatly as components of the waste stream. The coatings consisted of latex, waxes, emulsions, formaldehyde, organic and inorganic pigments and spills of undiluted coatings. The waste stream was beige in apparent color.

The waste samples were treated with a 3000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. A concentration of 3 ppm of the cationic polymer-emulsion polyacrylamide at 80% degree of charge, 8 million molecular weight was then added to gather the colorant. The treated waste was then filtered with a JWI plate and frame filter press with a polypropylene screen covered with a satin-finish cloth filter. The sludge was gravity fed for approximately 20 minutes. Then, the pump applied approximately 20 psi to the sample through the filter for approximately 60 minutes. Then, the pump pressure was increased to 40 psi for approximately 60 minutes and then increased to 60 psi for the remaining time to process the sample.

The treatment cycle time was limited only by the flow rate through the filter press, with the effluent through the filter press free of solids. The resultant effluent color (measured in platinum cobalt units) and filter cake quality observations are shown in Table 27 below.

TABLE 27

| | | CATIONIC | | |
|---|---|---|---|---|
| | | POLYMER-EMULSION | | |
| | POLYAMINE/ | POLYACRYLAMIDE, | COLOR- | FILTER |
| | ALUMINUM | 80% DEGREE OF | PLATINUM | PRESS |
| | CHLORIDE RATIO | CHARGE, 8 MILLION | COBALT | CAKE |
| | OF 50/50 | MOLECULAR WEIGHT | UNITS | QUALITY |
| DOSAGE | 3000 PPM | 3 PPM | 40 | DRY, |
| | | | | EASILY |
| | | | | REMOVED |
| | | | | FROM |
| | | | | CLOTH |

### Example 28

At an ink and coating manufacturing plant, both organic and inorganic coatings and inks are produced. Waste is generated by the “washdowns” of tanks between process changes and “washdowns” of floor spills. Both color concentration and solids levels vary greatly as components of the waste stream. The coatings consisted of latex, waxes, emulsions, formaldehyde, organic and inorganic pigments and spills of undiluted coatings. The waste stream was black in apparent color.

The waste samples were treated with a 3000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. A concentration of 3 ppm of the cationic polymer-emulsion polyacrylamide at 80% degree of charge, 8 million molecular weight was then added to gather the colorant. The treated waste was then filtered with a JWI plate and frame filter press with a polypropylene screen covered with a satin-finish cloth filter. The sludge was gravity fed for approximately 20 minutes. Then, the pump applied approximately 20 psi to the sample through the filter for approximately 60 minutes. Then, the pump pressure was increased to 40 psi for approximately 60 minutes and then increased to 60 psi for the remaining time to process the sample.

The treatment cycle time was limited only by the flow rate through the filter press, with the effluent through the filter press free of solids. The resultant effluent color (measured in platinum cobalt units) and filter cake quality observations are shown in Table 28 below.

TABLE 28

| | | CATIONIC | | |
|---|---|---|---|---|
| | | POLYMER-EMULSION | | |
| | POLYAMINE/ | POLYACRYLAMIDE, | COLOR- | FILTER |
| | ALUMINUM | 80% DEGREE OF | PLATINUM | PRESS |
| | CHLORIDE RATIO | CHARGE, 8 MILLION | COBALT | CAKE |
| | OF 50/50 | MOLECULAR WEIGHT | UNITS | QUALITY |
| DOSAGE | 3000 PPM | 3 PPM | 93 | DRY, |
| | | | | EASILY |
| | | | | REMOVED |
| | | | | FROM |
| | | | | CLOTH |

### Example 29

At a cardboard manufacturing facility, cardboard boxes are manufactured and specialty labeling for those boxes is produced. Waste is generated in the labeling process. Both color concentration and solids levels vary greatly as components of the waste stream. The coatings consisted of latex, waxes, emulsions, formaldehyde, organic and inorganic pigments and spills of undiluted coatings.

The waste samples were treated with a 3000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. Various concentrations of the cationic polymer-emulsion polyacrylamide at 80% degree of charge, 8 million molecular weight were then added to gather the colorant. The treated waste was then gravity-fed through a 50-micron mesh cloth filter. The treatment cycle time was limited only by the flow rate through the filter press, with the effluent through the filter press free of solids. The resultant effluent color (measured in platinum cobalt units) and settling time for solids observations are shown in Table 29 below.

TABLE 29

| | | | | |
|---|---|---|---|---|
| POLYAMINE | 50/50 | 50/50 | 50/50 | 50/50 |
| ALUMINUM | | | | |
| CHLORIDE | | | | |
| RATIO | | | | |
| DOSAGE | 3000 PPM | 3000 PPM | 3000 PPM | 3000 PPM |
| CATIONIC | 10 PPM | 20 PPM | 30 PPM | 40 PPM |
| POLYMER- | | | | |
| EMULSION | | | | |
| POLYACRYL- | | | | |
| AMIDE, 80% | | | | |
| DEGREE OF | | | | |
| CHARGE, 8 | | | | |
| MILLION | | | | |
| MOLECULAR | | | | |
| WEIGHT | | | | |
| COLOR- | 1207 | 2378 | 3510 | 4276 |
| PLATINUM | | | | |
| COBALT | | | | |
| UNITS | | | | |
| SETTLING- | 25 | 20 | 23 | 22 |
| TIME FOR | SECONDS | SECONDS | SECONDS | SECONDS |
| SOLIDS TO | | | | |
| SETTLE 50% | | | | |
| OF ORIGINAL | | | | |
| VOLUME | | | | |

### Example 30

At a cardboard manufacturing facility, cardboard boxes are manufactured and specialty labeling for those boxes is produced. Waste is generated in the labeling process. Both color concentration and solids levels vary greatly as components of the waste stream. The coatings consisted of latex, waxes, emulsions, formaldehyde, organic and inorganic pigments and spills of undiluted coatings.

The waste samples were treated with various concentrations of a 1:1 ratio of aluminum chloride solution and cationic polyamine. It was noted that the reaction for the aluminum chloride solution and cationic polyamine to remove the color from the waste solution was not time dependent. Minimal mixing was required. A 10 ppm concentration of the cationic polymer-emulsion polyacrylamide at 80% degree of charge, 8 million molecular weight was then added to gather the colorant. The treated waste was then gravity-fed through a 50-micron mesh cloth filter. The treatment cycle time was limited only by the flow rate through the filter press, with the effluent through the filter press free of solids. The resultant effluent color (measured in platinum cobalt units) and settling time for solids observations are shown in Table 30 below.

TABLE 30

| | | | | |
|---|---|---|---|---|
| POLYAMINE | 50/50 | 50/50 | 50/50 | 50/50 |
| ALUMINUM | | | | |
| CHLORIDE | | | | |
| RATIO | | | | |
| DOSAGE | 1000 PPM | 2000 PPM | 3000 PPM | 4000 PPM |
| CATIONIC | 10 PPM | 10 PPM | 10 PPM | 10 PPM |
| POLYMER- | | | | |
| EMULSION | | | | |
| POLYACRYL- | | | | |
| AMIDE, 80% | | | | |
| DEGREE OF | | | | |
| CHARGE, 8 | | | | |
| MILLION | | | | |
| MOLECULAR | | | | |
| WEIGHT | | | | |
| COLOR- | 3237 | 2873 | 1260 | 276 |
| PLATINUM | | | | |
| COBALT | | | | |
| UNITS | | | | |
| SETTLING- | 81 | 54 | 37 | 22 |
| TIME FOR | SECONDS | SECONDS | SECONDS | SECONDS |
| SOLIDS TO | | | | |
| SETTLE 50% | | | | |
| OF ORIGINAL | | | | |
| VOLUME | | | | |

### Example 31

At a cardboard manufacturing facility, cardboard boxes are manufactured and specialty labeling for those boxes is produced. Waste is generated in the labeling process. Both color concentration and solids levels vary greatly as components of the waste stream. The coatings consisted of latex, waxes, emulsions, formaldehyde, organic and inorganic pigments and spills of undiluted coatings.

The waste samples were treated with a 4000 ppm concentration of a 1:1 ratio of aluminum chloride solution and cationic polyamine. It was noted that the reaction for the aluminum chloride solution and cationic polyamine to remove the color from the waste solution was not time dependent. Minimal mixing was required. Various concentrations of the cationic polymer-emulsion polyacrylamide at 80% degree of charge, 8 million molecular weight was then added to gather the colorant. The treated waste was then gravity-fed through a 50-micron mesh cloth filter. The treatment cycle time was limited only by the flow rate through the filter press, with the effluent through the filter press free of solids. The resultant effluent color (measured in platinum cobalt units) and settling time for solids observations are shown in Table 31 below.

TABLE 31

| | | | | |
|---|---|---|---|---|
| POLYAMINE | 50/50 | 50/50 | 50/50 | 50/50 |
| ALUMINUM | | | | |
| CHLORIDE | | | | |
| RATIO | | | | |
| DOSAGE | 4000 PPM | 4000 PPM | 4000 PPM | 4000 PPM |
| CATIONIC | 5 PPM | 10 PPM | 15 PPM | 20 PPM |
| POLYMER- | | | | |
| EMULSION | | | | |
| POLYACRYL- | | | | |
| AMIDE, 80% | | | | |
| DEGREE OF | | | | |
| CHARGE, 8 | | | | |
| MILLION | | | | |
| MOLECULAR | | | | |
| WEIGHT | | | | |
| COLOR- | 375 | 278 | 210 | 458 |
| PLATINUM | | | | |
| COBALT | | | | |
| UNITS | | | | |
| SETTLING- | 22 | 21 | 23 | 22 |
| TIME FOR | SECONDS | SECONDS | SECONDS | SECONDS |
| SOLIDS TO | | | | |
| SETTLE 50% | | | | |
| OF ORIGINAL | | | | |
| VOLUME | | | | |

The invention being thus described, it will be obvious that the same may be varied in many ways. Such variations are not to be regarded as a departure from the spirit and scope of the invention and all such modifications are intended to be included within the scope of the following claims.

We claim:

1) A composition for the removal of colorant from a solution comprising:
a) an aluminum chloride solution; and
b) a cationic polyamine.

2) The composition of claim 1, wherein said aluminum chloride solution comprises aluminum chloride, hydrogen chloride, and water.

3) The composition of claim 1, wherein said aluminum chloride solution is 26%-28% aluminum chloride, 0%-1% hydrogen chloride, and 71%-74% water by volume.

4) The composition of claim 1, wherein said cationic polyamine contains 40%-60% degree of charge.

5) The composition of claim 1, wherein said cationic polyamine is selected from the group consisting of Callaway 4000 Series polyamine, Polymer Research 507, Chemtall 4420, Mid South 9507, Ashland Chemical Amerfloc series, Neo Solutions 3500.

6) The composition of claim 1, wherein said aluminum chloride solution is between 40% and 60% of the total volume and said cationic polyamine is between 40% and 60% of the total volume.

7) The composition of claim 1, wherein said aluminum chloride solution is approximately 50% of the total volume and said cationic polyamine is approximately 50% of the total volume.

8) A method of removing colorant from a solution comprising:
a) adding an effective amount of the composition of claim 1 to the solution to break the colorant from the solution;
b) adding an effective amount of a cationic polymer to enhance the settling of the colorant from the solution; and
c) filtering the solution.

9) The method of claim 8, wherein the amount of the composition of claim 1 that is added is between 500 ppm and 4000 ppm of the total volume of the solution.

10) The method of claim 8, wherein the amount of the cationic polymer that is added is between 0.01% and 1.0% of the total volume of the solution.

11) The method of claim 8, wherein the amount of the cationic polymer that is added is between 0.2% and 0.4% of the total volume of the solution.

12) The method of claim 8, wherein the cationic polymer has a molecular weight between approximately 6 million and approximately 12 million and has a degree of charge between approximately 10% and approximately 80%.

13) The method of claim 8, wherein the cationic polymer is selected from the group consisting of Cytec 1507, Chemtall EM804B and Neo Solutions 4422.

14) A method of removing colorant from a solution comprising:
a) adding an effective amount of the composition of claim 1 to the solution to break the colorant from the solution; and
b) filtering the solution by membrane filtration.

15) The method of claim 14, wherein the amount of the composition of claim 1 that is added is between 500 ppm and 4000 ppm of the total volume of the solution.
